(19) United States
(12) Patent Application Publication
(10) Pub. No.: US 2024/0229849 A1
(43) Pub. Date: Jul. 11, 2024

(54) Functional Part, and Functional System Comprising a Functional Part

(71) Applicant: Elringklinger AG, Dettingen (DE)

(72) Inventors: Daniel Ruff, Notzingen (DE); Florian Lieb, Bad Urach-Hengen (DE)

(73) Assignee: Elringklinger AG, Dettingen (DE)

(21) Appl. No.: 18/612,014

(22) Filed: Mar. 21, 2024

Related U.S. Application Data
(63) Continuation of application No. PCT/EP2022/075503, filed on Sep. 14, 2022.

(30) Foreign Application Priority Data
Sep. 23, 2021 (DE) 10 2021 124 713.6

(51) Int. Cl. F16B 21/04

(52) U.S. Cl. CPC F16B 21/04

(57) ABSTRACT

In order to improve a functional part, in particular a fitting, for example for a housing, comprising a connection receptacle or a plurality of connection receptacles, wherein the connection receptacle or each of the plurality of connection receptacles is configured to receive a connection mating piece of another part, in particular a connection mating piece of a housing part, in particular in the form of a bayonet closure in order to securely and releasably connect the functional part to the other part, it is proposed that the one connection receptacle or at least one connection receptacle, in particular some or each of the plurality of connection receptacles, is configured to receive connection mating pieces of different sizes, in particular so as to produce a secure connection.

### CROSS-REFERENCE TO RELATED PATENT APPLICATION

This application is a continuation of international application number PCT/EP2022/075503 filed on Sep. 14, 2022, and claims the benefit of German application No. DE 102021124713.6 filed on Sep. 23, 2021.

This patent application relates to the subject matter disclosed in and claims the benefit of international application PCT/EP2022/075503, filed Sep. 14, 2022, and German application No. DE 102021124713.6, filed Sep. 23, 2021. The teachings and disclosure of all of these patent applications are hereby incorporated in their entirety by reference thereto for all purposes.

### BACKGROUND OF THE INVENTION

The invention relates to a functional part, in particular a fitting, for example for a housing, wherein the functional part is configured for secure and releasable connection to a further part, in particular a housing part. The invention also relates to a functional system comprising such a functional part.

### SUMMARY OF THE INVENTION

The object of the invention is to improve such a functional part and/or such a functional system.

In the embodiments of the invention, this object is achieved by a functional part, in particular a fitting, for example for a housing, in that the functional part comprises a connection receptacle or a plurality of connection receptacles, wherein the connection receptacle or some, in particular each, of the plurality of connection receptacles is configured to receive a connection mating piece of another part, in particular a connection mating piece of a housing part, in particular in the form of a bayonet closure, in order to securely and releasably connect the functional part to the other part, wherein the one connection receptacle or at least one connection receptacle of the plurality of connection receptacles, in particular some, for example each of the plurality of connection receptacles, is configured to receive connection mating pieces of different sizes.

In particular, the one connection receptacle or at least one connection receptacle of the plurality of connection receptacles, in particular some, for example each of the plurality of connection receptacles, is configured to receive connection mating pieces of different sizes so as to establish a connection between the functional part and the other part.

In particular, therefore, the one connection receptacle or at least one connection receptacle, in particular some, preferably each, of the plurality of connection receptacles is configured to receive connection mating pieces of different sizes, whereby a connection is established between the functional part and the other part having the received connection mating piece.

For example, one advantage of embodiments of the invention is that the functional part can be connected to various other parts, the various other parts each having connection mating pieces of different sizes compared to another part. Thus, the functional part in particular can be used more flexibly.

In particular, it is sufficient in manufacture, for example, to produce this one type of functional part, and this one type of functional part is connectable to various other parts, in particular various embodiments of housings with housing walls of different thicknesses, which have connection mating pieces of different sizes compared with one another. In particular, it is therefore sufficient to manufacture this one type of functional part for a particular function, so that the number of different component variants decreases and, in particular, cost savings are made possible and/or a risk of mix-ups of the component variants and, for example, associated faults in the manufacture can be avoided or at least reduced.

No further details have yet been provided regarding the connection between the functional part and the at least one other part.

In particular, in a connection state between the functional part and the other part, a corresponding connection mating piece of the other part is received in at least one connection receptacle and a position of the functional part relative to the other part is fixed.

In the foregoing and in the following, the wording “at least one connection receptacle” in conjunction with a feature is to be understood as meaning that the one connection receptacle or one of the plurality of connection receptacles has the feature and/or that preferably some of the plurality of connection receptacles, in particular all of the plurality of connection receptacles, have this feature.

In particular, relative mobility of the functional part relative to the other part in the connection state is at least restricted, for example blocked, in at least one spatial dimension, preferably in at least two spatial dimensions, and preferably at least restricted in a third spatial dimension.

No further details have yet been provided regarding the form of the at least one connection.

In particular, it is provided that at least one connection receptacle, in particular some, for example each of the plurality of connection receptacles, has at least two contact surfaces.

Advantageously, the at least two contact surfaces are configured in such a way that a received connection mating piece is positionable between the at least two contact surfaces.

In particular, the positioning of the connection mating piece between the at least two contact surfaces defines a relative position of the connection mating piece relative to the connection receptacle and thus to the functional part.

Preferably, a relative movement of the received connection mating piece, and thus of the other part, relative to the connection receptacle, and thus to the functional part, is at least restricted, preferably blocked, in at least one spatial dimension, in particular in a receiving height direction in which the at least two contact surfaces are spaced apart from one another.

Advantageously, the at least two contact surfaces run at least approximately parallel to each other.

In particular, the at least two contact surfaces run at least approximately perpendicular to the receiving height direction.

In particular, the at least two contact surfaces extend in a longitudinal direction of extent of the at least one connection receptacle.

For example, at least one connection receptacle, in particular some, for example each of the plurality of connection receptacles, comprises at least one pair of two contact surfaces, the two contact surfaces of a particular pair being arranged opposite one another in a direction in which they are spaced apart from one another.

Preferably, at least one connection receptacle comprises, on at least one side of its receiving space, a plurality of contact surfaces arranged offset to one another in the receiving height direction, in particular these offset contact surfaces running in geometric planes that are at least approximately parallel to one another and/or are also arranged offset to one another in the longitudinal direction of extent.

In particular, the plurality of contact surfaces are offset from one another by at least 0.5 mm in the receiving height direction and/or offset from one another by a maximum of 5 mm, for example by a maximum of 2 mm in each case.

Advantageously, at least one connection receptacle, in particular some, for example each of the plurality of connection receptacles, has a plurality of pairs of two contact surfaces in each case.

The two contact surfaces of a particular pair are spaced apart from one another, in particular in the receiving height direction.

In particular, the two contact surfaces of a particular pair run at least approximately parallel to each other and the two contact surfaces of a particular pair run in particular at least approximately perpendicular to the direction in which they are spaced apart, in particular at least approximately perpendicular to the receiving height direction.

In particular, the distances between the two contact surfaces of a particular pair are different for the plurality of pairs. For example, the distances differ by at least 0.5 mm and/or by at most 4 mm in each case.

In particular, at least one connection receptacle, in particular each of the plurality of connection receptacles, thus has a plurality of pairs of mutually spaced-apart contact surfaces, the spacings being different from pair to pair, so that the connection receptacle can receive connection mating pieces of different sizes, which in particular have different thicknesses, and specifically in particular in each case connection mating pieces of which the thicknesses correspond at least approximately to the spacing between two contact surfaces in one of the plurality of pairs.

In particular, it is provided that the plurality of connection receptacles each have an equal number of a plurality of pairs of two contact surfaces and, for a corresponding distance, each of the plurality of connection receptacles has a pair of at least two contact surfaces spaced apart from one another at this distance.

In particular, at least one connection receptacle, in particular some, preferably each of the plurality of connection receptacles in each case, comprises a receiving space which is configured in particular to receive a connection mating piece to be received.

In some favorable embodiments measured in the receiving height direction, the receiving height is substantially constant along the at least approximately entire longitudinal extent of the receiving partial space in the longitudinal direction of extent.

In advantageous embodiments, the receiving height measured in the receiving height direction varies along the longitudinal direction of extent, in particular in steps and/or preferably in such a way that the receiving height becomes smaller with increasing distance in the longitudinal direction of extent from the receiving opening.

It is particularly advantageous if the receiving space comprises a plurality of receiving partial spaces which have different receiving heights.

In particular, the plurality of receiving partial spaces are formed with different receiving heights for receiving connection mating pieces of different sizes.

Preferably, the plurality of receiving partial spaces are connected to one another in the longitudinal direction of extent of the connection receptacle in a way that opens toward one another and merges into one another, so that a connection mating piece can advantageously be moved from a receiving partial space that is too large for this connection mating piece into a smaller receiving partial space arranged next.

In particular, the plurality of different receiving heights of the receiving partial spaces cover a receiving height range in the millimeter range.

Preferably, the minimum receiving height is at least 1 mm, for example at least 2 mm.

In particular, the receiving heights of different receiving partial spaces differ by at least 0.5 mm and/or by a maximum of 2 mm.

For example, a maximum receiving height is less than or equal to 15 mm, in particular less than or equal to 10 mm, for example less than or equal to 8 mm.

Preferably, a respective receiving partial space is defined between two contact surfaces of a particular pair.

In particular, the receiving height of a particular receiving partial space is the distance between the two contact surfaces that define this receiving partial space.

Thus, at least one connection receptacle, in particular some, preferably each of the plurality of connection receptacles, is configured to receive connection mating pieces of different sizes, in particular connection mating pieces with different thicknesses, in that these have a plurality of pairs of two contact surfaces in each case, the distances between the two contact surfaces being different in the plurality of pairs, and/or has a receiving space comprising a plurality of receiving partial spaces, the plurality of receiving partial spaces having different receptacle heights, and a corresponding connection mating piece can be brought into contact so as to produce a secure connection between the two contact surfaces of a pair, which are spaced apart from each other according to the thickness of the connection mating piece, and/or can be received in a receiving partial space with a receiving height corresponding to the thickness of the connection mating piece.

No further details have yet been provided regarding the further form of the one connection receptacle and/or the plurality of connection receptacles.

In preferred embodiments, it is provided that at least one connection receptacle, in particular some or each of the plurality of connection receptacles, comprises at least two retaining elements.

In particular, in the connection state in which the connection mating piece is received by the corresponding connection receptacle, a received connection mating piece is held by the at least two retaining elements so as to produce a secure connection.

Advantageously, the at least two retaining elements are spaced apart in a height direction of the corresponding connection receptacle.

In particular, it is provided that in at least one connection receptacle, preferably in some or each of the plurality of connection receptacles, the receiving space, for example comprising a plurality of receiving partial spaces, is at least partially formed between the at least two retaining elements.

In particular, the receiving space is at least partially formed in the receiving height direction between the at least two retaining elements.

Preferably, the at least two retaining elements at least partially delimit the receiving space.

Preferably, it is provided that in at least one connection receptacle, in particular in some or each of the plurality of connection receptacles, the at least two retaining elements each form at least one contact surface.

Advantageously, the at least two retaining elements of at least one pair, preferably of at least some pairs, for example of all pairs, form the two contact surfaces, so that in particular in the case of at least one pair of two contact surfaces, one contact surface is formed on one of the at least two retaining elements and the other of the two contact surfaces is formed on the other of the at least two retaining elements.

No further details have yet been provided regarding the form of the at least two retaining elements.

The retaining elements can be formed in a wide variety of ways in different embodiments.

In some advantageous embodiments, it is provided that at least one retaining element comprises plurality of step portions.

Preferably, this provides a structurally simple solution by means of which connection mating pieces of different sizes can be received in the connection receptacle with the retaining element comprising plurality of step portions and, in particular, are held in the connection state by the retaining element comprising step portions.

In particular, the plurality of step portions are arranged offset to one another, preferably offset to one another in the receiving height direction and/or offset to one another in the longitudinal direction of extent of the connection receptacle.

Preferably, connection mating pieces of different sizes can be received and held, for example, by the offset arrangement of the step portions in the receiving height direction, wherein, in particular, the offset arrangement in the longitudinal direction of extent of the step portions means that connection mating pieces of different sizes are received in different portions of the connection receptacle in relation to the longitudinal direction of extent.

Advantageously, it is provided that at least some, in particular all, of the plurality of step portions have a particular distance from a portion of another of the at least two retaining elements that is opposite in the receiving height direction, and the distances between each step portion and an opposite portion are different from one another.

In particular, this makes it possible in a simple manner that connection mating pieces of different sizes, in particular with different thicknesses, which in particular correspond to a distance between a step portion and an opposite portion, can be received in the connection receptacle between a corresponding step portion and a portion of another retaining element lying opposite and in particular form a secure connection by the seating between the corresponding step portion and the opposite portion, in which their relative position is advantageously fixed in at least one spatial dimension, namely in particular the receptacle height direction.

In particular, one of the plurality of receiving partial spaces is defined between each step portion and the particular opposite portion of another of the at least two retaining elements and this is advantageously limited by the step portion and the opposite portion in the receiving height direction.

Advantageously, it is provided that a contact surface is formed on at least one of the step portions, in particular on some or on each of the plurality of step portions.

For example, for each pair of two contact surfaces, a step portion is provided on at least one retaining element and forms one of the two contact surfaces of this pair.

In particular, two adjacent step portions are connected to each other at a corresponding step of the retaining element.

In some advantageous embodiments, it is provided that at least one retaining element has a contact surface which is flat at least in the receiving space along at least approximately its entire longitudinal extent.

In particular, the longitudinal extent of the contact surface runs in the longitudinal direction of extent of the connection receptacle and/or at least approximately perpendicular to the receiving height direction of the connection receptacle.

Preferably, receiving partial spaces with different heights are arranged along the longitudinal extent of the flat contact surface and are delimited in particular on at least one side by this flat contact surface.

Preferably, portions of the contact surface, which is flat at least in the receiving space along at least approximately its entire longitudinal extent, each form a contact surface of a pair of two contact surfaces, relative to which the second contact surface is arranged opposite, in particular as explained above.

In preferred embodiments, it is provided that at least one retaining element with a contact surface that is at least approximately flat along the entire longitudinal extent is arranged opposite a retaining element comprising plurality of step portions, so that advantageously between these two retaining elements a plurality of receiving partial spaces with different receiving heights and/or on these retaining elements a plurality of pairs of, in each case, two contact surfaces are formed, wherein in the case of different pairs the contact surfaces have different distances from each other.

For example, in some embodiments, an advantage of the contact surface, which is at least approximately flat along its entire longitudinal extent at least in the receiving space, is that a received connection mating piece can be guided along the flat contact surface in the receiving space until the connection mating piece reaches the matching receiving partial space and is received therein.

No further details have yet been provided with regard to further embodiments of the one connection receptacle and/or the plurality of connection receptacles.

In advantageous embodiments, it is provided that an end stop is arranged in at least one connection receptacle at a rear end of at least one receiving partial space in relation to an insertion direction for the connection mating piece.

In the foregoing and in the following, the wording “at least one receiving partial space” in conjunction with a feature is to be understood in particular as meaning that one receiving partial space has the feature or preferably a plurality of receiving partial spaces, for example all receiving partial spaces have this feature.

In advantageous embodiments, it is provided that an end stop is arranged at a rear end of at least one contact surface of at least one connection receptacle in relation to an insertion direction for the connection mating piece.

In the foregoing and in the following, the wording “at least one contact surface” is to be understood in particular to mean that one contact surface has the feature or preferably a plurality of, for example all, of the contact surfaces have the feature.

One advantage of the end stop, for example, is that when the connection mating piece is inserted, it can be placed against the end stop and thus its position can be fixed.

In particular, the end stop is configured as a stop in the insertion direction and has, for example, a stop surface that runs at least approximately perpendicular to the insertion direction.

In particularly preferred embodiments, it is provided that at least one end stop is formed by a step between two adjacent step portions.

Preferably, it is provided that a particular step forms an end stop for the receiving partial space and/or the contact surface arranged in front of it in relation to the insertion direction for the connection mating piece.

In particularly preferred embodiments, it is provided that a detent member is arranged at a front end, relative to the insertion direction for the connection mating piece, of at least one receiving partial space.

It is particularly advantageous if a detent member is arranged at the front end of at least one contact surface in relation to the insertion direction for the connection mating piece.

In particular, one advantage of this is that when the connection mating piece is inserted, the detent member enables the connection mating piece to be guided past and, when the connection mating piece is inserted into the appropriate receiving partial space and/or rests against the matching contact surface, the connection mating piece latches with the detent member and is thus held in the corresponding receiving partial space and/or against the corresponding contact surface.

Preferably, the detent member is configured to be at least partially deformable, so that in particular a connection mating piece can be guided past the detent member for insertion into and removal from a corresponding receiving partial space and/or a connection mating piece can be guided past the deformable detent member for contact with a corresponding contact surface and removal from a contact surface.

Different forms of the detent member are possible.

In particularly preferred embodiments, it is provided that, for at least one contact surface, a detent member is formed by a latching lug which protrudes beyond a level of the contact surface and which is in particular at least partially deformable.

For example, the latching lug protrudes beyond the level of the contact surface in the receiving height direction.

In particular, the level of the contact surface is a height level in which the contact surface extends at least approximately, and the latching lug rises beyond the height level in order to hold in contact a connection mating piece resting against the contact surface.

Preferably, the detent member, for example the latching lug, is formed of a retaining element.

In preferred embodiments, it is provided that, in relation to the insertion direction for the connection mating piece, a guide surface extending in the insertion direction and running at an angle to the receiving height direction is arranged in front of at least one receiving partial space and/or in front of at least one contact surface.

In particular, the guide surface, which runs at an angle to the receiving height direction, successively reduces a receiving height in the receiving height direction and thus facilitates the insertion of a connection mating piece into the at least one receiving partial space and/or the guiding of the connection mating piece to the at least one contact surface.

In particular, the guide surface is configured to run at an angle to the receiving height direction such that, with increasing extent in the insertion direction, the guide surface runs increasingly in the receiving height direction toward a side of the connection receptacle opposite the receiving height direction, for example toward a side of the receiving space opposite and/or toward a contact surface opposite.

In some preferred embodiments, it is provided that at least one inclined guide surface transitions at least partially into at least one detent member.

In particular, the inclined guide surface makes it easier to guide the connection mating piece over the detent member to latch behind the detent member.

For example, in some advantageous embodiments it is provided that at least one inclined guide surface is at least partially formed from at least one detent member.

In some advantageous embodiments, at least one guide surface transitions into a contact surface, so that in particular the placement of a connection mating piece against this contact surface is facilitated.

No further details have yet been provided regarding the arrangement of the at least two retaining elements.

In some preferred embodiments, it is provided that the at least two retaining elements are arranged rigidly relative to each other.

For example, this achieves stable hold of a connection mating piece received between the two retaining elements.

In particular, the rigid arrangement of the at least two retaining elements offers a structurally simple and, in particular, low-maintenance solution.

In some favorable embodiments, it is provided that at least one retaining element is force-loaded.

For example, the at least one retaining element is spring-loaded.

In particular, it is provided that the force is applied to the at least one retaining element in the direction of a reduction in the size of the receiving space.

In particular, in such embodiments it is provided that the at least two retaining elements are arranged to be movable relative to one another at least and/or only within a stroke path for the application of force to the at least one retaining element, in particular in the receiving height direction.

For example, one advantage of this is that a connection mating piece held by the at least one retaining element is held more firmly by the application of force.

In some advantageous embodiments, it is provided that the force applied to the at least one retaining element is configured for tolerance compensation.

This means that greater tolerances are possible, particularly for the connection mating piece, and yet a receiving fit forming a secure connection is still possible.

For example, a stroke path during the application of force, for example a spring travel of a spring that applies the force, is in the range of tenths of a millimeter, for example the stroke path, in particular the spring travel, is less than or equal to 1 mm, for example less than or equal to 0.7 mm.

In some favorable embodiments, it is provided that the force applied to the at least one retaining element is configured to compensate for the height of the receiving space for receiving connection mating pieces of different sizes.

In particular, the at least one force-loaded retaining element is mounted so as to be movable relative to the other retaining element within a receiving height range relative to the other of the at least two retaining elements.

In particular, the receiving height range is defined between a minimum receiving height and a maximum receiving height of the receiving space.

In this way, the connection receptacles can be used to receive connection mating pieces of which the size, in particular thickness, lies within the receptacle height range by means of the retaining element that is force-loaded with receptacle height compensation, wherein compensation for the different sizes is provided by the force-loaded retaining element, which is in particular mounted movably relative to the other retaining element, so that the retaining elements can advantageously hold connection mating pieces of different sizes between them.

In particular, a stroke path of the force application, for example a spring travel of a spring that applies the force, and/or the receiving height range are in the millimeter range.

In particular, the stroke path, in particular the spring travel, and/or the receiving height range is greater than or equal to 1 mm, preferably greater than or equal to 2 mm, and/or less than or equal to 10 mm, for example less than or equal to 6 mm.

In advantageous embodiments, it is provided that at least one retaining element of at least one connection receptacle, preferably at least one retaining element in the case of plurality of, for example all, connection receptacles, is arranged on an engagement body of the functional part.

In particular, the engagement body engages in an opening of the other part in a connection state.

In some favorable embodiments, the at least one retaining element arranged on the engagement body is attached to the latter and/or, for example, molded on.

In other advantageous embodiments, the at least one retaining element arranged on the engagement body is formed in one piece with the latter.

In particular, a free space is provided between each two adjacent connection receptacles, with the receiving space of one of the two connection receptacles preferably opening into the free space by means of a receiving opening.

In particular, when connecting the functional part to the other part, a particular connection mating piece is first positioned in the free space and then inserted into one of the adjacent connection receptacles.

In advantageous embodiments, it is provided that the functional part comprises at least one stop element, the at least one stop element being configured in particular to fix a relative position of the functional part relative to the other part in one direction, in particular in a direction axial to a connection axis, when connecting the functional part to the other part.

Preferably, it is provided that at least a part of the stop element extends along the free spaces and thus advantageously at least facilitates or enables positioning of the connection mating piece for insertion into the connection receptacle.

In advantageous embodiments, it is provided that at least one retaining element of at least one connection receptacle, for example at least one retaining element in some, for example in all, of the plurality of connection receptacles, is formed by the stop element of the functional part for the other part.

In particular, the stop element extends at least partially along both the connection receptacle and at least partially along the free space adjacent to the connection receptacle.

Advantageously, the connection mating piece can first be positioned in the free space on the stop element and then inserted along the stop element into the connection receptacle and is held in the connection receptacle by the portion of the stop element forming the retaining element.

For example, the stop element is formed by a stop ring running circumferentially around a connection axis.

No further details have yet been provided with regard to other advantageous embodiments and arrangements of the connection receptacles.

Preferably, the plurality of connection receptacles are arranged in a ring region around a connection axis.

In particular, the plurality of connection receptacles have substantially the same radial distance to the connection axis.

In some favorable embodiments, the plurality of connection receptacles are arranged substantially rotationally symmetrically to the connection axis.

In advantageous embodiments, the engagement body has a substantially cylindrical outer side on which the plurality of connection receptacles are arranged.

In particular, the functional part is connected to the other part, in particular by receiving a particular connection mating piece in the corresponding connection receptacle, by rotating the functional part, in particular in a closing direction of rotation, about the connection axis.

Preferably, at least one connection receptacle, in particular each of the plurality of connection receptacles, comprises a receiving opening.

In particular, the receiving opening is configured so that, when connecting the functional part to the other part, a particular connection mating piece can be inserted through the receiving opening into the corresponding connection receptacle.

In particular, the connection receptacle, in particular its receiving space, which may comprise a plurality of receiving partial spaces, extends away from the receiving opening, in particular as far as an opposite rear end of the connection receptacle.

In particular, the longitudinal direction of extent of a connection receptacle corresponds at least substantially to a circumferential direction around the connection axis.

In particular, the insertion direction for a particular connection mating piece is the longitudinal direction of extent oriented away from the receiving opening, for example toward an end of the connection receptacle lying opposite.

In particular, at least one connection receptacle, in particular each of the plurality of connection receptacles, has an open longitudinal side which extends in the longitudinal direction of extent.

In particular, a corresponding connection mating piece with a portion engaging in the connection receptacle can thus engage in the connection receptacle through the open longitudinal side and can be moved along the longitudinal direction of extent in the connection receptacle in order to be positioned, for example, in a suitable receiving partial space and/or between a pair of two contact surfaces at a suitable distance.

In particular, the open longitudinal side of the connection receptacle is an outer side of the connection receptacle directed radially outward in relation to the connection axis.

In particular, the one connection receptacle is, or the plurality of connection receptacles are, for a bayonet closure.

Advantageously, the connection receptacle or the connection receptacles together with the connection mating piece or the connection mating pieces form a bayonet closure.

No further details have yet been provided with regard to further embodiments of the functional part.

In particular, the functional part comprises at least one functional component for performing a function.

In advantageous embodiments, it is provided that the functional part is a fluid-guiding part and, in particular, at least one functional component is configured to guide a fluid.

For example, the functional part comprises a valve, for example a pressure equalization valve, in particular as a functional component.

In some favorable embodiments, it is provided that the functional part has a closure element as a functional component.

Alternatively or additionally, in embodiments of the invention, the object stated at the outset is achieved by a functional system with a functional part, the functional part having at least one, preferably a plurality, of the features explained above.

In particular, in the functional system, the other part for forming a connection to the functional part is a housing part of a housing of the functional system.

In particular, the housing part has the connection mating pieces as another part.

Preferably, the connection mating pieces are formed from a housing wall of the housing part, for example they are extensions of the housing wall.

In particular, the thickness of the housing wall corresponds to the size of the connection mating pieces, in particular the thickness of the connection mating pieces.

In particular, the other part, in particular the housing part, has an opening at which the functional part can advantageously be connected to the other part.

In particular, the opening is configured to interact with the functional part.

Preferably, the opening is configured for at least partial insertion of the engagement body of the functional part.

In particular, it is provided that the one connection mating piece for the one connection receptacle and/or the plurality of connection mating pieces for one each of the plurality of connection receptacles protrude from an opening edge of the opening into the opening.

Preferably, the opening edge has an at least approximately circular shape.

In particular, the housing can be configured for different applications.

In some favorable embodiments, it is provided that the housing is a battery housing.

The features above and hereinafter which are described as being provided in particular and/or for example and/or preferably and/or advantageously and/or the like are optional features which, for example, define advantageous further developments, but are not absolutely necessary for the success according to the invention.

In the foregoing and in the following, the wording “substantially” in conjunction with a specification is to be understood in particular to mean that technically irrelevant and/or technically induced deviations from the given specification, for example a direction and/or a value, are included in the substantially stated specification.

In particular, the wording “at least approximately” in conjunction with a specification is to be understood as meaning that this specification is at least substantially stated and/or that deviations of, for example, up to ±10%, in particular up to ±5%, in particular up to ±1%, are included in the specification stated at least approximately.

For example, approximately stated directions include deviations of up to 10°, in particular of up to 5°, for example of up to 1°, from the at least approximately stated direction.

The above description of solutions according to the invention thus comprises in particular the various combinations of features defined by the following consecutively numbered embodiments:
1. A functional part (110), in particular a fitting, for example for a housing (120), comprising one connection receptacle (262) or a plurality of connection receptacles (262), wherein the connection receptacle (262) or each of the plurality of connection receptacles (262) is configured to receive a connection mating piece (152) of another part, in particular a connection mating piece (152) of a housing part (122), in particular in the form of a bayonet closure in order to securely and releasably connect the functional part (110) to the other part
   wherein the one connection receptacle (262) or at least one connection receptacle (262), in particular some or each of the plurality of connection receptacles (262), is configured to receive, in particular receive so as to produce a secure connection, connection mating pieces (152) of different sizes.
2. A functional part (110) in accordance with the preceding embodiment, wherein at least one connection receptacle (262), in particular each of the plurality of connection receptacles (262), has at least two contact surfaces (284, 322, 324, 326), wherein the at least two contact surfaces (284, 322, 324, 326) are spaced apart from one another in the receptacle height direction.
3. A functional part (110) in accordance with the preceding embodiments, wherein at least one connection receptacle (262), in particular some or each of the plurality of connection receptacles (262), has a plurality of pairs of two contact surfaces (284, 322, 324, 326), wherein two contact surfaces (284, 322, 324, 326) of a particular pair are spaced apart from one another, in particular in the receiving height direction (277), and the distances between two contact surfaces (284, 322, 324, 326) of a particular pair are of different sizes in the plurality of pairs.
4. A functional part (110) in accordance with the preceding embodiments, wherein at least one connection receptacle (262), in particular some or each of the plurality of connection receptacles (262), has a receiving space (276) which comprises a plurality of receiving partial spaces (332, 334, 336), and the plurality of receiving partial spaces (332, 334, 336) have different receiving heights, wherein in particular a particular receiving height is measured between a particular portion of one of the at least two retaining elements (272, 274) in the receiving height direction (277).
5. A functional part (110) in accordance with the preceding embodiments, wherein a respective receiving partial space (276) is defined between two contact surfaces (284, 322, 324, 326) of a particular pair, wherein in particular the receiving height of a respective receiving partial space (276) is the distance between the two contact surfaces (284, 322, 324, 326) which define this receiving partial space (276).
6. A functional part (110) in accordance with the preceding embodiments, wherein at least one connection receptacle (262), in particular some or each of the plurality of connection receptacles (262), comprises at least two retaining elements (272, 274), wherein the at least two retaining elements (272, 274) are spaced apart from one another, in particular in a receptacle height direction (277).
7. A functional part (110) in accordance with the preceding embodiments, wherein in at least one connection receptacle (262) the receiving space (276) between the at least two retaining elements (272, 274) is formed at least partially and/or in at least one connection receptacle (262) the at least two retaining elements (272, 274) each form at least one contact surface (284, 322, 324, 326).
8. A functional part (110) in accordance with the preceding embodiments, wherein at least one retaining element (272, 274) comprises a plurality of step portions (312, 314, 316), wherein in particular the plurality of step portions (312, 314, 316) are arranged offset relative to one another in the receiving height direction (277).
9. A functional part (110) in accordance with the preceding embodiments, wherein at least some, in particular all, of the plurality of step portions (312, 314, 316) have a particular distance from a portion of another of the at least two retaining elements (272, 274) which is in each case opposite in the receiving height direction (277), and the distances between in each case one step portion (312, 314, 316) and an opposite portion are different from one another.
10. A functional part (110) in accordance with the preceding embodiments, wherein a contact surface (284, 322, 324, 326) is formed on at least one of the step portions (312, 314, 316), in particular on some or on each of the plurality of step portions (312, 314, 316).
11. A functional part (110) in accordance with the preceding embodiments, wherein in each case two step portions (312, 314, 316) of a retaining element (272, 274) arranged adjacent to one another are connected to one another at a respective step of the retaining element (272, 274).
12. A functional part (110) in accordance with the preceding embodiments, wherein at least one retaining element (272, 274) has a contact surface (284, 322, 324, 326) which is flat at least in the receiving space (276) along its at least approximately entire longitudinal extent, wherein in particular the longitudinal extent runs in the direction of longitudinal extent (278) of the connection receptacle (262) and/or at least approximately perpendicular to the receiving height direction (277) of the connection receptacle (262).
13. A functional part (110) in accordance with the preceding embodiments, wherein an end stop (362, 364, 366) is arranged at a rear end of at least one receiving partial space (332, 334, 336) and/or at least one contact surface (284, 322, 324, 326) of at least one connection receptacle (262) with respect to an insertion direction for the connection mating piece (152).
14. A functional part (110) in accordance with the preceding embodiments, wherein at least one end stop (362, 364, 366) is formed by a step between two adjacent step portions (312, 314, 316).
15. A functional part (110) in accordance with the preceding embodiments, wherein a detent member (372, 374, 376) is arranged at a front end of at least one receiving partial space (332, 334, 336) and/or at least one contact surface (284, 322, 324, 326) with respect to the insertion direction for the connection mating piece (152).
16. A functional part (110) in accordance with the preceding embodiments, wherein, for at least one contact surface (284, 322, 324, 326), a detent member (372, 374, 376) is formed by a latching lug which protrudes beyond a level of the contact surface (284, 322, 324, 326), in particular protrudes in the receiving height direction (277).
17. A functional part (110) in accordance with the preceding embodiments, wherein, with respect to the insertion direction for the connection mating piece (152), a guide surface (382, 384, 386) extending in the insertion direction and running at an angle to the receiving height direction (277) is arranged in front of at least one receiving partial space and/or in front of at least one contact surface (284, 322, 324, 326), wherein the guide surface (382, 384, 386) runs in particular at an angle to the receiving height direction (277), such that, with increasing extent in the insertion direction, the guide surface (382, 384, 386) runs increasingly in the receiving height direction (277) toward an opposite side of the connection receptacle (262).
18. A functional part (110) in accordance with the preceding embodiments, wherein at least one inclined guide surface (382, 384, 386) transitions at least partially into at least one detent member (372, 374, 376) and/or is formed at least partially from at least one detent member (372, 374, 376).
19. A functional part (110) in accordance with the preceding embodiments, wherein the at least two retaining elements (272, 274) are arranged rigidly relative to one another.
20. A functional part (110) in accordance with the preceding embodiments, wherein at least one retaining element (272, 274) is force-loaded, in particular spring-loaded, wherein in particular the force is applied in the direction of a reduction of the receiving space (276).
21. A functional part (110) in accordance with the preceding embodiments, wherein the application of force to the at least one retaining element (272, 274) is configured for tolerance compensation.
22. A functional part (110) in accordance with the preceding embodiments, wherein the application of force to the at least one retaining element (272, 274) is configured to compensate for the height of the receiving space (276) for receiving connection mating pieces (152) of different sizes.
23. A functional part (110) in accordance with the preceding embodiments, wherein at least one retaining element (272, 274) of at least one connection receptacle (262) is arranged on an engagement body (232) engaging in an opening (126) of the other part in the one connection state.
24. A functional part (110) in accordance with the preceding embodiments, wherein at least one retaining element (272, 274) of at least one connection receptacle (262) is formed by a stop element, in particular on a stop ring (242), of the functional part (110) for the other part.
25. A functional part (110) in accordance with the preceding embodiments, wherein the plurality of connection receptacles (262) are arranged in a ring region around a connection axis (234).
26. A functional part (110) in accordance with the preceding embodiments, wherein at least one connection receptacle (262), in particular each of the connection receptacles (262) in each case, has a receiving opening (344) and the connection receptacle (262), in particular its receiving space (276), extends away from the receiving opening (344) in the longitudinal direction of extent (278).
27. A functional part (110) in accordance with the preceding embodiments, wherein the one connection receptacle (262) or the plurality of connection receptacles (262) form connection receptacles (262) for a bayonet closure.
28. A functional part (110) in accordance with the preceding embodiments, wherein the functional part is a fluid-guiding part, in particular having a valve and/or a closure element.
29. A functional system with a functional part (110) in accordance with the preceding embodiments, wherein in particular the other part for forming a connection to the functional part (110) is a housing part (122) of a housing (120) of the functional system.
30. A functional system in accordance with the preceding embodiment, wherein the other part, in particular the housing part (122), has an opening (126), in particular for cooperation with the functional part (110) and/or for at least partial insertion of the engagement body (232) of the functional part (110), wherein the one connection mating piece (152) or the plurality of connection mating pieces (152) protrude from an opening edge (142) of the opening (126) into the opening (126).
31. A functional system in accordance with the two preceding embodiments, wherein the housing is a battery housing.

Preferred embodiments and advantages of the invention are the subject of the following detailed description of plurality of embodiments and the drawings thereof.

### BRIEF DESCRIPTION OF THE DRAWINGS

In the drawings:

FIG. 1 shows a perspective view of an exemplary embodiment of a functional element;

FIG. 2 shows a further perspective view of the functional part;

FIG. 3 shows a plan view of an insertion side of the functional part;

FIG. 4 shows an enlarged view of a connection receptacle of the functional part;

FIG. 5 shows a perspective view of a detail of a housing part with a housing opening for connection to the functional part;

FIG. 6 shows a perspective view of the functional part in a connection state with a housing part with a thick housing wall;

FIG. 7 shows a perspective view of the functional part in a connection state with a housing part having an average housing wall thickness;

FIG. 8 shows a perspective view of the functional part in a connection state with a housing part with a housing wall having a small thickness;

FIG. 9 shows a perspective view, similar to FIG. 1, of another exemplary embodiment of a functional part;

FIG. 10 shows a view of a disk spring with a portion forming a retaining element;

FIG. 11 shows a sectional view of a further exemplary embodiment of a functional part with a spring-loaded retaining element.

### DETAILED DESCRIPTION OF THE INVENTION

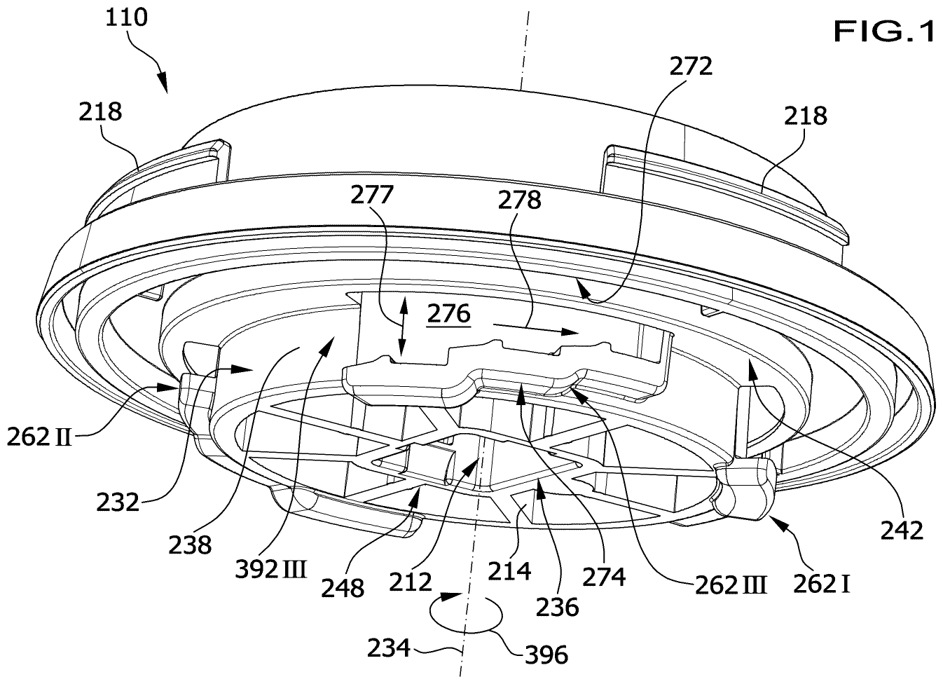

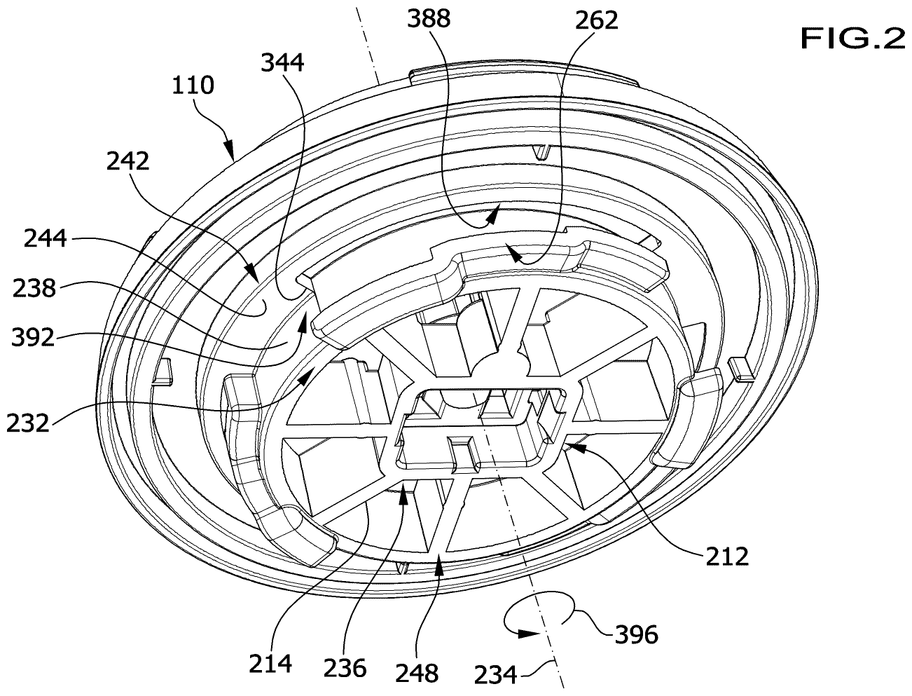

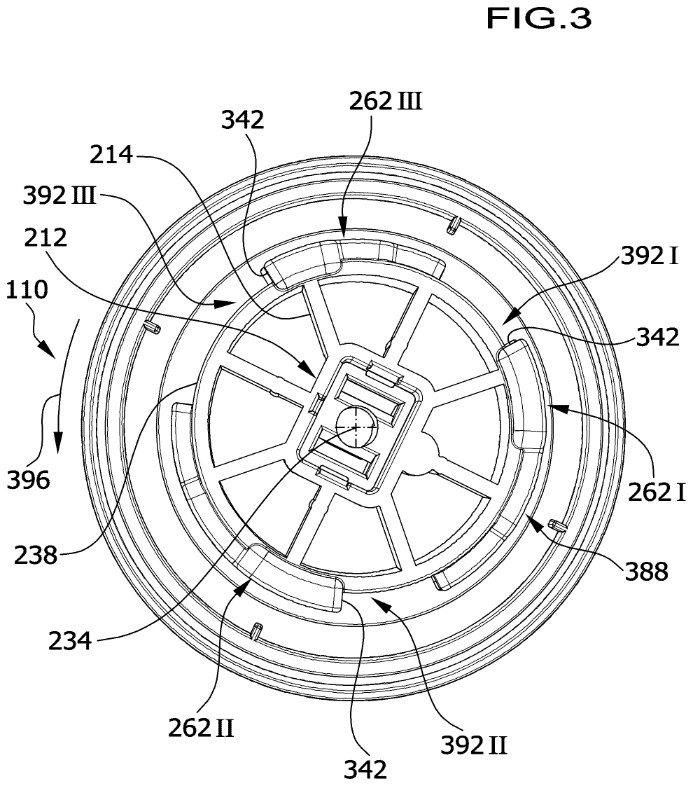

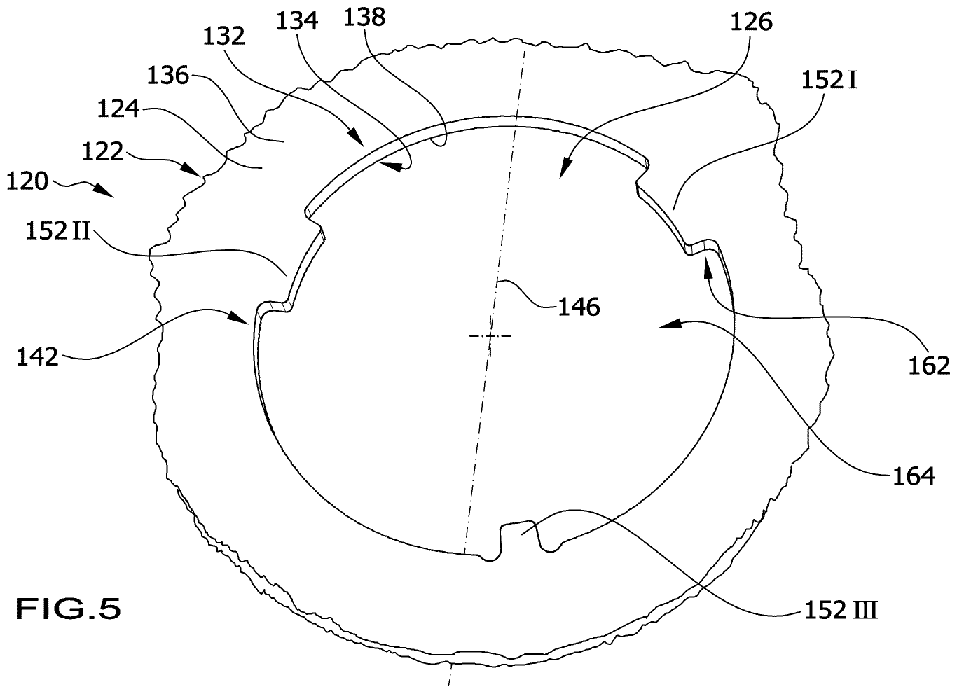

In a first exemplary embodiment, a functional part 110, which is shown by way of example in FIGS. 1 to 4, and a housing designated as a whole by 120, a detail of which is shown by way of example in FIG. 5, together form a functional system.

The functional part 110 and the housing 120 are formed such that they can be securely connected by a releasable connection, wherein in a released state the functional part 110 is separate from the housing 120 and in particular freely movable relative to the housing 120, and in a connection state the functional part 110 and the housing 120 are securely connected to one another, a relative position of the functional part 110 to the housing 120 being fixed in the connection state.

The housing 120 comprises at least one housing part 122 with a housing wall 124, which has a housing opening 126 at which the functional part 110 can be connected to the housing part 122 and thus also to the housing 120. In particular, the functional part 110 engages at least partially into the housing opening 126 in the connection state.

The housing opening 126 extends from one side 132 of the housing wall 124, in particular an outwardly oriented outer side of the housing 120, through the housing wall 124 to an opposite side 134 of the housing wall 124, in particular an inwardly oriented inner side of the housing 120, for example to an interior of the housing 120.

In particular, the housing wall 124 extends substantially in a geometric housing plane at least in a region around the housing opening 126, one side 132 of the housing wall 124 running on one side of the geometric housing plane and the other side 134 of the housing wall 124 running on an opposite side of the housing plane, and preferably a surface 136 on the one side 132, in particular an outer surface on the outer side, and a surface 138 on the other side 134, in particular an inner surface on the inner side, and the geometric housing plane running substantially parallel to each other at least in this region around the housing opening 126.

In particular, an extent of the housing wall 124 along the sides 132 and 134, and thus in particular substantially along the geometric housing plane, is substantially greater, for example at least 10 times greater, in particular at least 50 times greater, than an extent of the housing wall 124 from one side 132 to the other side 134, and thus in particular at least approximately perpendicular to the geometric housing plane.

The extent of the housing wall 124 from one side 132 to the other side 134 is hereinafter also referred to as the thickness of the housing wall 124.

In particular, the thickness of the housing wall 124 is at least substantially constant along the extent of the sides 132 and 134, and thus along the extent of the geometric housing plane, at least in the region around the housing opening 126.

Preferably, the housing opening 126 has an at least substantially circular shape with respect to a plan view of one of the sides 132, 134, in particular a projection of the housing opening 126 onto the geometric housing plane having an approximately circular shape.

The housing opening 126 is surrounded by an opening edge 142, the opening edge 142 substantially defining the circular shape of the housing opening 126.

In particular, the housing opening 126 extends openly through the housing wall 124 in a direction perpendicular to the geometric housing plane and is delimited perpendicularly thereto by the opening edge 142.

In particular, the housing opening 126 is thus concentric with an opening axis 146, the opening edge 142 running around the housing opening 126 in a peripheral direction around the opening axis 146 and delimiting the housing opening 126 in a radial direction with respect to the opening axis 146 and a center of the circular shape of the opening edge 142 lying on the opening axis 146.

A radial extent of the housing opening 126 is defined here from the opening axis 146 in the radial direction up to the opening edge 142.

In particular, the opening axis 146 is aligned at least approximately perpendicular to the geometric housing plane.

A plurality of connection mating pieces 152, for example three connection mating pieces 152I, 152II, 152III, extend from the opening edge 142 into the housing opening 126, in particular the connection mating pieces 152 being extensions of the housing wall 124 and having the same thickness, which in particular is measured perpendicular to the geometric housing plane, as the housing wall 124.

In this case, the connection mating pieces 152 extend from the opening edge 142 into an outer ring region 162 of the housing opening 126, a radial width of the outer ring region 162 corresponding to a radial extent of the connection mating pieces 152, 154, 156.

The outer ring region 162 is defined in a radial direction relative to the opening axis 146 between the opening edge 142 and an inner region 164 of the housing opening 126, the inner region 164 extending radially outward from the opening axis 146 with an extent which corresponds to a radial distance from the opening axis 146 of a radially most inwardly extending part of the connection mating pieces 152, so that the connection mating pieces 152 do not extend into the inner region 164

Preferably, the functional part 110 comprises at least one functional component 212, in particular for guiding a fluid, wherein, for example, the functional component 212 comprises a fluid passage 214 and preferably a valve, for example a pressure equalization valve.

In particular, the functional component 212 for guiding a fluid is formed with fluid-guiding elements such that a flow of the fluid and/or a pressure transmission through the fluid in particular from an interior of the housing 120 to an outer region of the housing arranged outward relative to the interior of the housing is controlled, in particular the fluid-guiding elements comprising valves, fluid passages and/or closures.

In some variants of the exemplary embodiment, the functional component 212 is formed as a closure element and, in particular, the functional part 110 is a closure.

In some favorable variants, the functional component 212 comprises fastening elements 218, for example detent elements, in particular for fastening functional units, so that when the functional part 110 is connected to the housing 120, the functional units, for example for control and/or further processing of a fluid, in particular for fastening a connection port, can be fastened to the housing 120 by means of the functional part 110 with the fastening elements 218.

For connecting the functional part 110 to the housing 120, the functional part 110 comprises in particular an engagement body 232, which at least partially engages in the housing opening 126 in the connected state.

The engagement body 232, relative to a connection axis, has a radial extent 234 which is less than or equal to the radial extent of the inner region 164 of the housing opening 126 and, for example, the engagement body 232 is at least substantially rotationally symmetrical with respect to the connection axis 234.

In the connection state between the functional part 110 and the housing 120, the connection axis 234 coincides at least substantially with the opening axis 146.

For example, the fluid passage 214 extends in a direction axial to the connection axis 234 from a side 236 of the engagement body 232 engaging in the housing opening 126 through the latter to an opposite side of the functional part 110.

Preferably, the engagement body 232 has a cylindrical outer side 238 relative to the connection axis 234.

Preferably, the functional part 110 has a stop ring 242 which surrounds the engagement body 232 peripherally and which, at least in parts, extends radially further outward in relation to the connection axis 234 than the radial extent of the housing opening 126, so that in the connection state the stop ring 242 rests at least partially against the opening edge 142 and thus defines how far the engagement body 232 engages into the housing opening 126 in the connection state.

In particular, the stop ring 242 has a stop surface 244 which runs at least approximately perpendicularly to the connection axis 234, preferably extends radially outward from the engagement body 232, and runs peripherally around the engagement body 232.

The stop surface 244 faces an insertion side 248 of the functional part 110, said insertion side being formed for example by the engaging side 236 of the engagement body 232, the insertion side 248 being an axial end side of the functional part 110 relative to the connection axis 234 and by means of which the functional part 110 is inserted into the housing opening 126.

In particular, the engagement body 232 has an axial end 252 on the engaging side 236 with respect to the connection axis 234 and, in the connection state, the engagement body 232 engages into the housing opening 126 with its part extending from the axial end 252 to the axial position of the stop surface 244 in the axial direction with respect to the connection axis 234.

For the connection to the housing 120, the functional part 110 comprises a plurality of connection receptacles 262, each of the connection receptacles 262 being configured to receive a corresponding connection mating piece 152, for example a connection receptacle 262I is configured to receive the connection mating piece 152I, a connection receptacle 262II is configured to receive the connection mating piece 152II, and a connection receptacle 262III is configured to receive the connection mating piece 152III.

In particular, the connection receptacles 262 together with the connection mating pieces 152 form a bayonet closure.

At least in terms of the basic functions, the plurality of connection receptacles 262 preferably have the same form, and therefore these are described together in the following and, in particular, reference is only made to a particular one or to some of the plurality of connection receptacles 262 insofar as individual connection receptacles 262 have a substantially different form.

The connection receptacle 262 has two retaining elements 272 and 274, which are spaced apart from one another in the axial direction relative to the connection axis 234 and between which a receiving space 276 for the connection mating piece 152 is formed and defined.

The receiving space 276 and thus the connection receptacle 262 extends between the two retaining elements 272, 274 in a longitudinal direction of extent 278, which substantially corresponds to a peripheral direction around the connection axis 234.

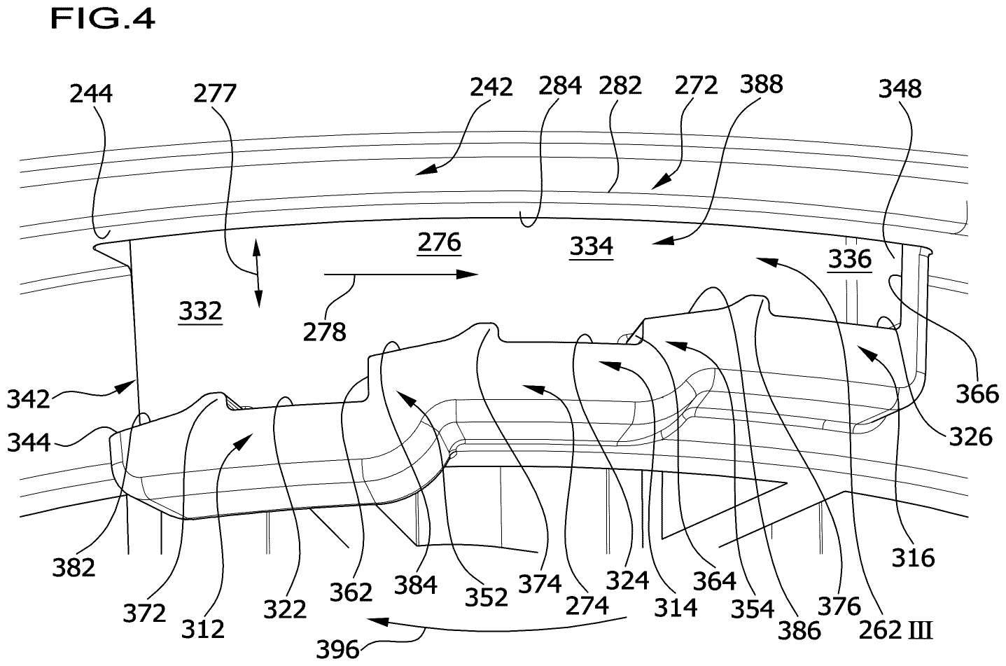

A connection receptacle, here the connection receptacle 262III, is shown enlarged by way of example in FIG. 4.

In particular, one of the retaining elements, here the retaining element 272, is formed by a retaining portion 282 of the stop ring 242, so that along the retaining portion 282 the stop surface 244 of the stop ring 242 also forms a contact surface 284 for the connection receptacle 262.

In this case, the contact surface 284 of the retaining element 272 formed by the stop ring 242 is a contact surface facing the other retaining element 274 and flat along the longitudinal direction of extent 278 of the connection receptacle 262.

The other of the two retaining elements, here the retaining element 274, is offset in the axial direction to the connection axis 234 relative to the other retaining element, here the retaining element 272, and is arranged closer to the insertion side 248.

In particular, the further retaining element 274 is stepped and has a plurality of step portions, here for example three step portions 312, 314, 316, the step portions 312, 314, 316 being arranged one behind the other in the longitudinal direction of extent 278 and having contact surfaces 322, 324, 326 arranged offset to one another in the receiving height direction 277.

In particular, the contact surface 322 of the step portion 312 forms a first pair of contact surfaces with a portion of the contact surface 284 of the other retaining element 272 that is opposite in the height direction 277 of the receiving space 276, between which pair of contact surfaces a first receiving partial space 332 of the receiving space 276 is formed, and the contact surface 324 of the step portion 314 arranged next in the longitudinal direction of extent 178 forms a second pair of contact surfaces with a portion of the contact surface 284 of the other retaining element 272 opposite in the receiving height direction 277, between which second pair of contact surfaces a second receiving partial space 334 of the receiving space 276 is formed, and the contact surface 326 of the step portion 316 arranged next in the longitudinal direction of extent 278 forms a further pair of contact surfaces with a portion of the contact surface 284 of the other retaining element 272 opposite in the receiving height direction 277, between which further pair of contact surfaces a third receiving partial space 336 of the receiving space 276 is formed.

In particular, the contact surfaces 322, 324, 326 of the plurality of step portions 312, 314, 316 run at least approximately perpendicular to the receiving height direction 277 and at least approximately parallel to portions of the contact surface 284 of the other retaining element 272 opposite in the receiving height direction 277.

In this case, the plurality of step portions 312, 314, 316 are arranged and formed in such a way that, in the case of step portions 314, 316 arranged downstream in the longitudinal direction of extent 278, their contact surface 324, 326 is arranged closer to the corresponding portion of the contact surface 284 of the other retaining element 272 lying opposite in the receiving height direction 275 than the contact surface 322, 324 of a step portion 312, 314 arranged upstream in the longitudinal direction of extent 278.

Thus, respective receiving heights, which are measured in the receiving height direction 277, of the receiving partial spaces 332, 334, 336 arranged one behind the other in the longitudinal direction of extent 278 become increasingly smaller in the order in which these receiving partial spaces 332, 334, 336 are arranged one behind the other in the longitudinal direction of extent 278; in particular, the receiving height of the receiving space 276 becomes gradually smaller.

The longitudinal direction of extent 278 is oriented from an opening end 342, at which the connection receptacles 262 have a receiving opening 344 opening into the receiving space 276, toward a rear end 346, at which the receiving space 276 is closed in the longitudinal direction of extent 278, in particular by a terminating stop 348.

The receiving opening 344 opens in the longitudinal direction of extent 278 into the receiving space 276 and in particular into the receiving partial space arranged furthest forward in relation to the longitudinal direction of extent 278, which also has the greatest receiving height, in this case the receiving partial space 332.

For example, the step portion 312 is arranged closest to the receiving opening 344 in the longitudinal direction of extent 278 and, with its contact surface 322 and the portion of the contact surface 284 of the other retaining element 272 opposite in the receiving height direction 277, defines the receiving partial space 332 with the greatest receiving height, and the step portion 314 arranged next in the longitudinal direction of extent 278, with its contact surface 324 and the portion of the contact surface 284 of the other retaining element 272 opposite in the receiving height direction 277, defines the receiving partial space 332 with the second-greatest receiving height, and the step portion 316 arranged next in the longitudinal direction of extent 278 and also arranged furthest back in this example, with its contact surface 326 and the portion of the contact surface 284 of the other retaining element 272 opposite in the receiving height direction 277, defines the receiving partial space 336 with the third-largest receiving height, this also being the smallest receiving height in this exemplary embodiment.

In particular, the receiving partial space arranged furthest to the rear in the longitudinal direction of extent 278, here the receiving partial space 336, is delimited in the longitudinal direction of extent 278 by the terminating stop 348 at the rear end 346.

The receiving space 276 and thus also its receiving partial spaces 332, 334, 336 are preferably delimited in the radial direction relative to the connection axis 234 on their radial inner side by the engagement body 232, on which, for example, the stepped retaining element 274 is arranged, and are open radially outward.

In particular, the stop surfaces 284, 322, 324, 326 of the retaining elements 272, 274 run into a ring region around the connection axis 234, which substantially corresponds to the outer ring region 162 of the housing opening 126.

In particular, a minimum radial distance of the contact surfaces 284, 322, 324, 326 from the connection axis 234 is greater than or equal to a maximum radial distance of the engagement body 232 from the connection axis 234.

A maximum radial distance from the connection axis 234 of the contact surfaces 284, 322, 324, 326 is at most equal to or smaller than the radial extent of the housing opening 126.

In particular, at least the retaining element closer to the insertion side 248, in this case the retaining element 274, which is in particular stepped, extends radially outward in the radial direction relative to the connection axis 234 at most up to a maximum radial extent, the maximum radial extent being less than or equal to the radial extent of the housing opening 126.

In particular, the stop ring with its stop surface 244 projects beyond the retaining elements with their contact surfaces 284, 322, 324, 326 in the radial direction relative to the connection axis 234.

Each two step portions 312, 314, 316 arranged adjacent to each other are preferably connected to each other by one step 352, 354 of the stepped retaining element 274.

For example, the step portion 312 arranged furthest forward in the longitudinal direction of extent 278 and the step portion 314 located closest in the longitudinal direction of extent 278 are connected to each other by the step 352, and the step portion 316 located furthest back in the longitudinal direction of extent 278 is connected to the step portion 314 located immediately in front in the longitudinal direction of extent 278 by the step 354.

It is particularly advantageous if an end stop 362, 364, 366 is arranged on each of the contact surfaces 322, 324, 326 of the plurality of step portions 312, 314, 316 at a corresponding rear end with respect to the longitudinal direction of extent 278, the end stops 362, 364, 366 each forming a delimitation in the longitudinal direction of extent 278.

Preferably, an end stop 362, 364 for a contact surface 322, 324 of a step portion 312, 314, relative to which at least one further step portion 314, 316 is arranged downstream in the longitudinal direction of extent 278, is formed by the corresponding step 352, 354 of the retaining element 274, said step connecting the corresponding step portion 312, 314 to the step portion 314, 316 arranged immediately downstream in the longitudinal direction of extent 278.

For example, the end stop 366 for the contact surface 326 of the step portion 316 arranged furthest back in the longitudinal direction of extent 278 is formed by the terminating stop 348.

In particular, at least the end stops 362, 364, which are arranged at a rear end of a contact surface 322, 324 of a step portion 312, 314, relative to which at least one further step portion 314, 316 is arranged downstream in the longitudinal direction of extent 278, have a height in the receiving height direction 277, which substantially corresponds to the difference between the receiving height of the receiving partial space 332, 334, which is defined by the contact surface 322, 324 delimited by the corresponding end stop 362, 364, and the receiving height of the receiving partial space 334, 336 immediately downstream in the longitudinal direction of extent 278, or is less than this difference.

Preferably, a difference in height between the height of the end stop 362, 364 and the difference in the receiving heights of the receiving partial spaces arranged immediately downstream is compensated for by an inclined guide surface, which is described in greater detail below.

Preferably, respective detent members 372, 374, 376 are arranged at respective front ends of each contact surface 322, 324, 326 of the retaining element 274, which in particular is stepped, relative to the longitudinal direction of extent 278.

Each detent member 372, 374, 376 extends beyond a corresponding level of the contact surface 322, 324, 326 in the receiving height direction 277 beyond this level in the direction of the other retaining element 272, in particular the level of the particular contact surface 322, 324, 326 being its axial position along the connection axis 234.

In particular, the detent members 372, 374, 376 are at least partially elastic and can thus be pushed back and/or deformed, in particular in the receiving height direction 277, so that their distance from the oppositely arranged retaining element 272 can be at least slightly increased in the receiving height direction 277.

For example, the detent members 372, 374, 376 are formed as deformable latching lugs projecting beyond the axial level of the corresponding contact surface 322, 324, 326 and formed from the retaining element 274.

For example, the detent members 372, 374, 376 are only provided in one connection receptacle, for example in the connection receptacle 262III.

In other variants of the exemplary embodiment, a corresponding detent member is provided on a plurality, for example all, of the connection receptacles 262 for at least some of the contact surfaces.

Preferably, guide surfaces 382, 384, 386 are formed for respective contact surfaces 322, 324, 326 of respective step portions 312, 314, 316 and extend in the longitudinal direction of extent 278 and run at an angle to the receiving height direction 277, in such a way that, with increasing extent in the longitudinal direction of extent 278, a distance between a particular guide surface 382, 384, 386 and a surface of the other retaining element 272 arranged opposite in the receiving height direction 277, for example an opposite portion of the contact surface 284 of the other retaining element 272, reduces, that is to say in particular the receiving height of the receiving space reduces continuously along the guide surface 382, 384, 386.

In particular, a corresponding guide surface 384, 386 is provided between each two adjacent contact surfaces 322, 324 and 324, 326.

For example, a corresponding guide surface 384, 386 extends from an edge of an end stop 362, 364, which delimits a contact surface 322, 324 arranged in front of it in the longitudinal direction of extent 278, in the longitudinal direction of extent 278 toward the contact surface 324, 326 arranged immediately behind it, the edge of the end stop 362, 364 being arranged at a distance, in particular above, the contact surface 322, 324 arranged in front of it in the receiving height direction 277.

In particular, a guide surface 382 is arranged at the receiving opening 344 in front of the contact surface 322 of the step portion 312 arranged furthest forward with respect to the longitudinal direction of extent 278.

In some favorable variants, for example in some connection receptacles, here in the case of the connection receptacles 262I, 262II, a guide surface 382, 384, 386 arranged upstream with respect to the longitudinal direction of extent 278 transitions into the contact surface 322, 324, 326 following it with respect to the longitudinal direction of extent 278.

In some favorable variants, in particular in connection receptacles 262 with detent members 372, 374, 376, as here in the case of the connection receptacle 262III, a corresponding guide surface 382, 384, 386 preferably transitions into a surface of a detent member 372, 374, 376 arranged in front of the corresponding contact surface 322, 324, 326.

The connection receptacles 262 have an open longitudinal side 388, which extends from the receiving opening 344 in the longitudinal direction of extent 278, for example, to the rear end 346.

The open longitudinal side 388 is open outward in the receiving height direction 277 between the two retaining elements 272, 274, in particular between the two contact surfaces 284, 322, 324, 326 lying opposite one another, in particular in the radial direction relative to the connection axis 234, so that in the connection state a corresponding connection mating piece 152 can engage in the connection receptacle through the open longitudinal side 388.

In particular, the plurality of connection receptacles 262 are arranged on the radial outer side 238 of the engagement body 232 with respect to the connection axis 234 and are preferably arranged symmetrically, i.e., in particular with approximately equal spacing between two adjacent connection receptacles 262.

For example, the connection receptacles 262 are made of plastic and molded onto the engagement body 232.

In variants of the initial example, the connection receptacles 262 and the engagement body 232 are formed in one piece, for example as a one-piece injection-molded part made of plastic.

With respect to a peripheral direction around the connection axis 234, a corresponding free space 392 extends away from each of the connection receptacles 262, starting from their particular opening end 342, in the direction of the adjacent connection receptacle 262 and in particular as far as the adjacent connection receptacle 262.

Thus, for example, a free space 392I extends from the opening end 342 of the connection receptacle 262I away therefrom in the direction of the connection receptacle 262III, a free space 392II extends from the opening end 342 of the connection receptacle 262II away therefrom in the direction of the connection receptacle 262I, and a free space 392III extends from the opening end 342 of the connection receptacle 262III away therefrom in the direction of the connection receptacle 262II.

The corresponding free space 392 is open toward the insertion side 248 in the axial direction relative to the connection axis 234 and is delimited on the opposite side by the stop surface 244 of the stop ring 242.

The receiving space 276 of each of the connection receptacles 262 is connected through the corresponding receiving opening 344 to the free space 392 adjacent to and extending away from the opening end 342.

In particular, a mode of operation and advantages of the functional part 110, the housing 120 and the functional system comprising it is thus briefly summarized as follows.

A releasable secure connection between the functional part 110 and the housing 120 can be produced by means of the connection receptacles 262 receiving respective connection mating pieces 152, and in particular together form a bayonet fastener, wherein in the connection state in which the functional part 110 is securely connected to the housing 120, for example, the connection mating piece 152I is received in the connection receptacle 262I, the connection mating piece 152II is received in the connection receptacle 262II, and the connection mating piece 152III is received in the connection receptacle 262III, for which purpose the respective connection mating pieces 152 and connection receptacles 262 are configured to correspond to one another in terms of their dimensions.

To establish the connection, the functional part 110 is aligned with the housing opening 126 so that the connection axis 234 of the functional part 110 coincides at least substantially with the opening axis 146 of the housing opening 126 and the insertion side 248 of the functional part 110 faces the housing opening 126.

In addition, the functional part 110 must be aligned in such a way that the free spaces 392 are arranged opposite the connection mating pieces 152 in the axial direction relative to the opening axis 146 and connection axis 234.

The functional part 110 aligned in this way is then at least partially inserted into the housing opening 126, so that the engagement body 232 is at least partially in engagement with the housing opening 126 and the connection mating pieces 152 engage in a respective free space 392, in particular, the connection mating piece 152I engages in the free space 392I, the connection mating piece 152II engages in the free space 392II and the connection mating piece 152III engages in the free space 392III, with the corresponding free spaces 392 being suitably large for this purpose.

Since the engagement body 232 has a radial extent which is not greater than the radial extent of the inner region 164 of the housing opening 126, it can be inserted radially inwardly past the connection mating pieces 152 into the housing opening 126.

The connection receptacles 262 extend radially to the connection axis 234 and thus in the aligned state also radially to the opening axis 146 no further outward than the radial extent of the housing opening 126 up to the opening edge 142, so that the connection receptacles 262 can be positioned in the outer ring region 162 of the housing opening 126 between the connection mating pieces 152 when the functional part 110 is inserted.

Here, the positioning of the connection receptacles 262 is such that a connection mating piece 152 to be received by a connection receptacle 262 is positioned in the corresponding free space 392 extending away from the opening side 342 of the connection receptacle 262.

In particular, the functional part 110 is inserted into the housing opening 126 until the connection mating pieces 152 come into contact with the stop surface 244 of the stop ring 242 and then the functional part 110 is rotated in a closing direction of rotation 396 about the connection axis 234, so that the particular connection mating piece 152 is received by this connection receptacle 262 through the corresponding receiving opening 344 of a connection receptacle 262, for example the connection mating piece 152I is received by the connection receptacle 262I, the connection mating piece 152II is received by the connection receptacle 262II, and the connection mating piece 152III is received by the connection receptacle 262III.

The closing direction of rotation 396 is oriented in such a way that, during rotation, the respective opening end 342 of each connection receptacle 262 is at the front and the respective rear end 346 is at the rear of the particular connection receptacle 262 with respect to the rotation.

If the respective connection piece 152 is received in the corresponding connection receptacle 262, wherein it engages in particular through the open longitudinal side 388 in the connection receptacle 262, it is held between the two retaining elements 272 and 274 by these and a connection state between the functional part 110 and the housing 120 is made possible, in which these are securely connected to one another.

In this connection state, the connection mating pieces 152 are received in the corresponding connection receptacle 262 in such a way that their direction of extent, in which their thickness is measured, corresponds to the receiving height direction 277, and since the connection receptacles 262 each have a plurality of receiving partial spaces 332, 334, 336 with different receiving heights in the receiving height direction 277, wherein, for each receiving partial space 332, 334, 336, a corresponding pair of contact surfaces, here a corresponding portion of the contact surface 284 of the one retaining element 272 and a contact surface 322, 324, 326 of a corresponding step portion 312, 314, 316 of the other, in particular stepped, retaining element 274, are spaced apart from one another in the receiving height direction 277 correspondingly to the respective receiving heights of the receiving partial spaces 332, 334, 336, the connection receptacles 262 can receive connection mating pieces 152 having different thicknesses, namely having thicknesses which correspond to a corresponding receiving height of the particular receiving partial spaces 332, 334, 336.

The flat stop surface 244 of the stop ring 242 is advantageous here, since, when the functional part 110 is inserted, the connection mating pieces 152 come to rest against this stop surface 244 and are then guided along the stop surface 244 into the corresponding connection receptacle 262 when the functional part 110 is rotated in the closing direction of rotation 396.

In addition, the guide surface 382 at the receiving opening 344, which is the first to interact with the connection mating piece 152 to be removed during rotation in the closing direction of rotation 396, is favorable, since this inclined guide surface 382 makes the receiving opening 344 preferably larger in the receiving height direction 277 than the receiving height of the receiving space 276, in particular larger than each of the different receiving heights of the various receiving partial spaces 332, 334, 336 and the successively decreasing receiving height due to the inclined guide surface 382 facilitates insertion of the connection mating piece 152 into the connection receptacle 262.

The functional part 110 is rotated in the closing direction of rotation 396 until the corresponding connection mating piece 152 is positioned in the receiving partial space 332, 334, 336 with the receiving height corresponding to the thickness of the connection mating piece 142, with correct positioning being facilitated in particular by the corresponding end stop 362, 364, 366 at the corresponding end of the contact surface 322, 324, 326.

Here, again, the guide surfaces 382, 384, 386, with which the connection mating piece 152 to be positioned may interact before it is positioned in the corresponding receiving partial space 332, 334, 336, are advantageous, since the receiving height is successively reduced by these inclined guide surfaces 382, 384, 386, hereby facilitating insertion of the connection mating piece 152 into the corresponding receiving partial space 332, 334, 336.

In addition, the corresponding detent member 372, 374, 376, which is arranged in the longitudinal direction of extent 278 at the end of the corresponding contact surface 322, 324, 326 opposite the end stop 362, 364, 366, is particularly favorable, so that the received connection mating piece 152 is held in the longitudinal direction of extent 276 between the end stop 362, 364, 366 and the detent member 372, 374, 376, this connection mating piece 152 bearing against the contact surface 322, 324, 326 between the detent member 372, 374, 376 and the end stop 362, 364, 366.

In particular, the connection mating piece 152 is held by the detent member 372, 374, 376 in that the corresponding detent member 372, 374, 376 protrudes beyond the level of the contact surface 322, 324, 326.

In particular, the insertion of the corresponding connection mating piece 152 into the matching receiving partial space 332, 334, 336 by means of the detent member 372, 374, 376 arranged at the front of this receiving partial space 332, 334, 336 is made possible by the fact that the detent member 372, 374, 376 is configured to be at least partially deformable and thus the connection mating piece 152 can be guided past the detent member 372, 374, 376 by deformation of the detent member 372, 374, 376.

Analogously, the connection between the guide part 110 and the housing 120 can be released again by rotating the functional part 110 about the connection axis 234 against the closing direction of rotation 396, so that the connection mating piece 152 is guided out of the corresponding receiving partial space 332, 334, 336, this being made possible in particular, by a deformation of the detent member 372, 3374, 376, and, when the connection mating pieces 152 are arranged in the corresponding free spaces 392, the functional part 110 can be removed from the housing opening 126 in the axial direction relative to the opening axis 146.

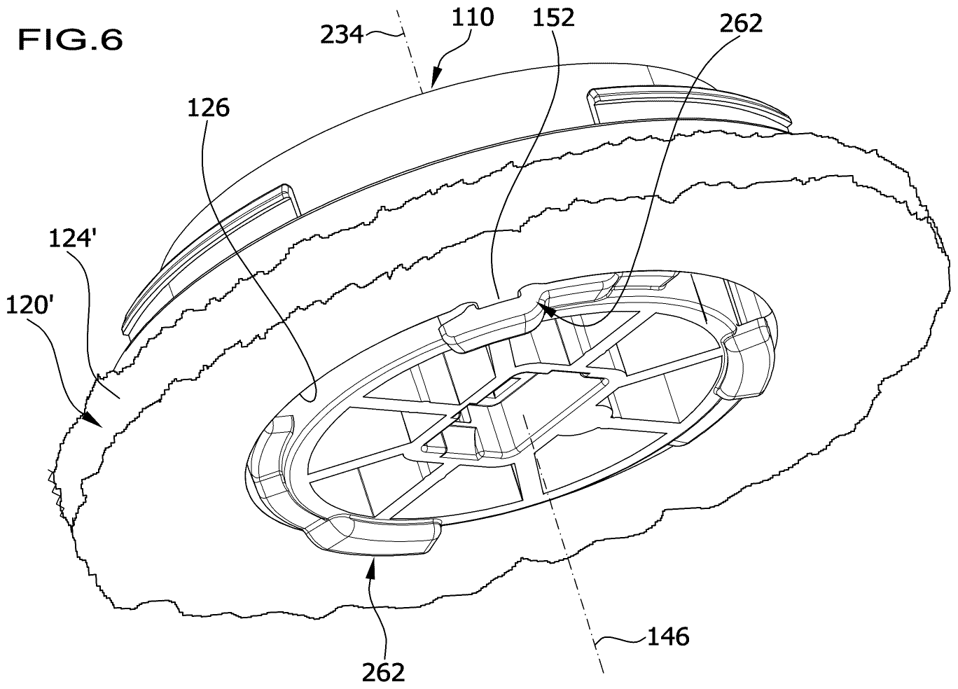

In FIGS. 6 to 8, the functional part 110 is shown in different connection states with different housings 120′, 120″, 120′″, each of which has a housing wall 124′, 124″, 124′″, the thicknesses of the housing walls 124′, 124″, 124′″ being different, more specifically in particular the housing thickness 124′ corresponding to the receiving height of the receiving partial space 332 with the largest receiving height, the thickness of the housing wall 124″ corresponding to the receiving height of the receiving partial space 334 with the second largest receiving height, and the thickness of the housing wall 124′″ corresponding to the receiving height of the receiving partial space 336 with the smallest receiving height.

As explained above, the corresponding connection mating piece 152 is received in the corresponding receiving partial space, in particular held between the end stop 362, 364, 366 and the detent member 372, 374, 376 in the longitudinal direction of extent 278 and rests in the receiving height direction 277 against opposing contact surfaces 284, 322, 324, 326 of the corresponding pair of contact surfaces, which corresponds to the particular receiving partial space 332, 334, 336.

Thus, for example, in the case of the housing 120′ with a housing wall 124′, the thickness of which corresponds to the receiving partial space 332 with the greatest receiving height, the connection mating piece 152, which is positioned in this receiving partial space 332, is in contact with the contact surface 322 and with the portion of the contact surface 284 opposite with respect to the receiving height direction 277, these forming the pair of contact surfaces of this receiving partial space 332, and is arranged in particular between the end stop 362 and the detent member 372, as shown by way of example in FIG. 6.

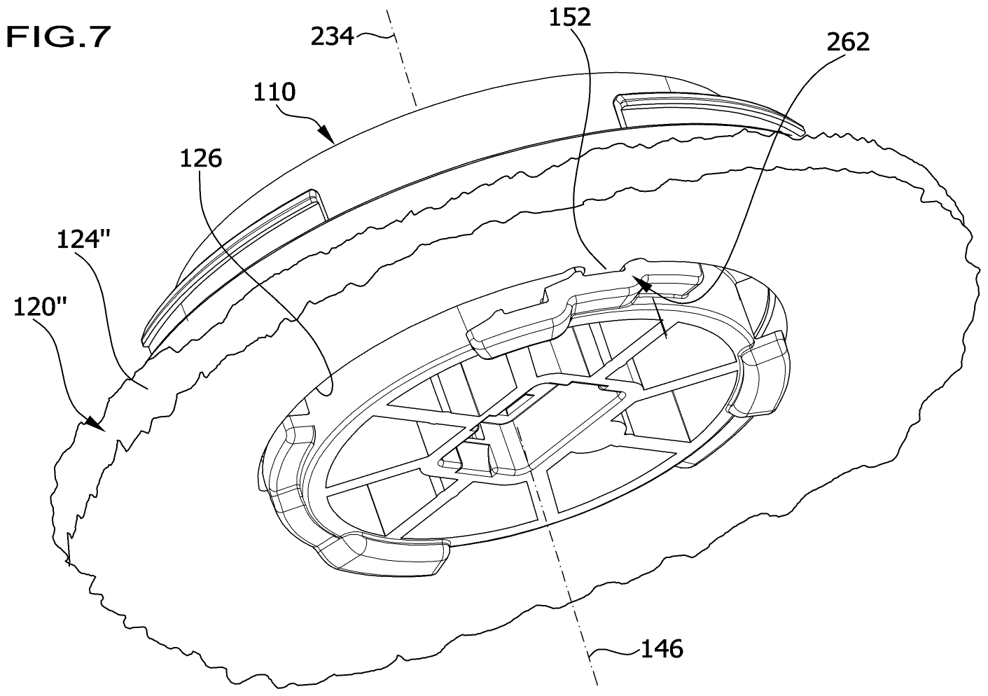

In particular, the connection mating piece 152, for the housing 120″ with the housing wall 124″, which has a thickness corresponding to the receiving height of the receiving partial space 334 with the second-largest receiving height, is positioned in this receiving partial space 334 and rests against the contact surface 324 and the portion of the contact surface 284 of the other retaining element 272 lying opposite in the receiving height direction 277, and is arranged in particular in the longitudinal direction of extent 278 between the end stop 364 and the detent member 374 of this receiving partial space 334, as shown by way of example in FIG. 7.

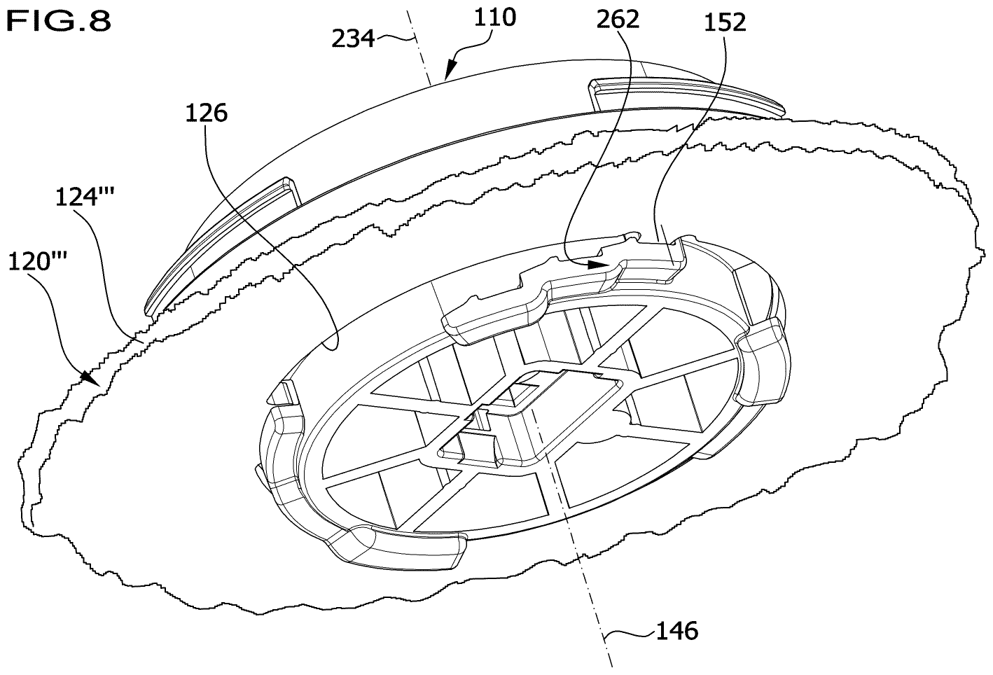

In particular, the connection mating piece 152 of the housing 120′″, which has a housing wall 124′″ with a thickness corresponding to the receiving height of the receiving partial space 336 with the smallest receiving height, is positioned in this receiving partial space 336 and lies against its contact surface 326 and the portion of the contact surface 284 of the other retaining element 272 lying opposite in the receiving height direction 277, these forming the corresponding pair of contact surfaces for this receiving partial space 336, and in particular lies between the end stop 366, which is formed in particular by the terminating stop 348, and the detent member 376 of this receiving partial space 336 with respect to the longitudinal direction of extent 278, as shown by way of example in FIG. 8.

In the foregoing, in particular the receiving of the connecting part 152III in the connection receptacle 262III, in which detent members 372, 374, 376 are provided, has been explained, with these explanations also applying correspondingly to the receiving of the connection mating piece 152I in the connection receptacle 262I and the receiving of the connection mating piece 152II in the connection receptacle 262II, wherein, for example, no detent members 372, 374, 376 are provided in these connection receptacles 262I and 262II, and thus the corresponding connection mating piece 152I, 152II merely rests against the corresponding end stop 362, 364, 366 in the longitudinal direction of extent 278.

When connecting the functional part 110 to the housing 120″ with the housing wall 124″ with the medium thickness, which is therefore smaller than the receiving height of the receiving partial space 332 with the largest receiving height and which is larger than the receiving height of the receiving partial space 336 with the smallest receiving height and which corresponds, for example, to the receiving height of the receiving partial space 334 with the receiving height lying between the largest and smallest receiving heights, when rotating in the closing direction of rotation 396 about the connection axis of rotation 234, the connection mating piece is first moved through the receiving partial space 332 with the largest receiving height before this connection mating piece 152 reaches the receiving partial space 334 with the corresponding receiving height which receives this connection mating piece 152.

When establishing the connection between the functional part 110 and the housing 120′″ with the housing wall 124′″, which has a thickness which corresponds to the receiving height of the receiving partial space 336 with the smallest receiving height, when the functional part 110 is rotated in the closing direction of rotation 396, the corresponding connection mating piece 152 is first moved through the receiving partial spaces with greater receiving heights arranged in front of it in the longitudinal direction of extent 278, in this case through the receiving partial spaces 332 and 334, until the connection mating piece 152 reaches the receiving partial space 336 receiving it and is received therein.

In the case of further exemplary embodiments, those features and elements which fulfill at least the same basic function and/or are at least substantially of the same configuration as features and/or elements in the first exemplary embodiment explained are assigned the same reference numerals and, in order to avoid repetitions, reference is made in terms of content to the description thereof in conjunction with the other exemplary embodiments, in particular to the description of the exemplary embodiment explained above, provided that nothing deviating and/or supplementary is explained in conjunction with an exemplary embodiment. In particular, if reference is to be made in particular to an embodiment in one of the other exemplary embodiments, a letter characterizing this exemplary embodiment is added to the corresponding reference numeral as a suffix.

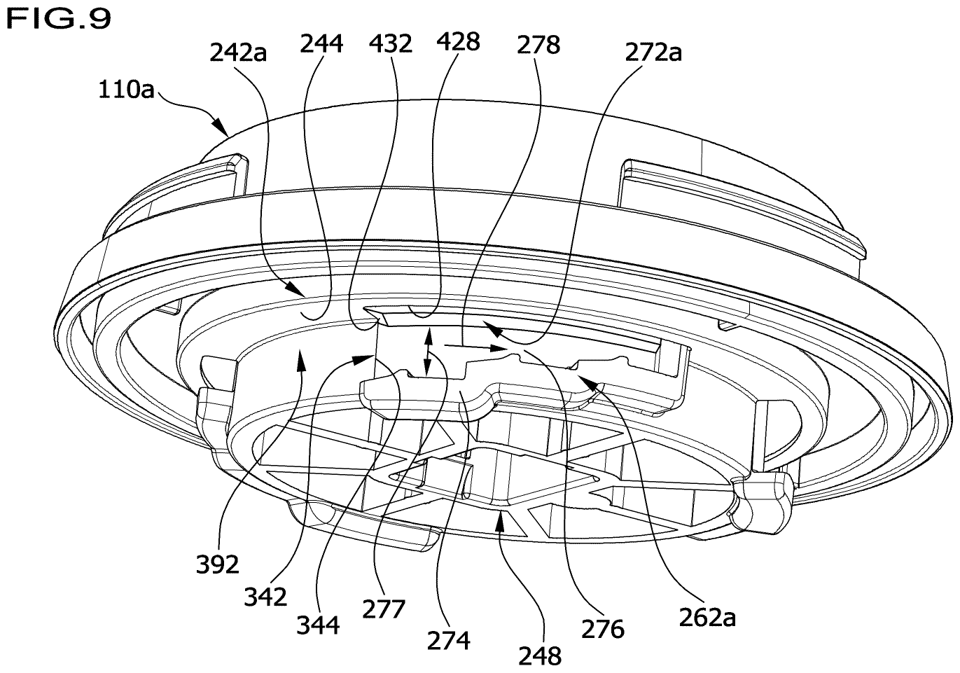

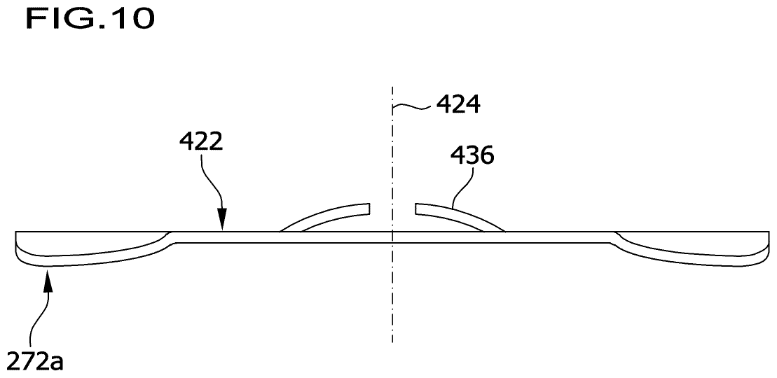

A functional part 110a of a further exemplary embodiment, which is shown by way of example in FIGS. 9 and 10, has a plurality of connection receptacles 262a, which are configured to receive connection mating pieces 152 of a housing part 122 of a housing 120, which in particular protrude into a housing opening 126, as shown by way of example in FIG. 5.

In particular, the connection receptacles 262a comprise two retaining elements 272a and 274, between which a receiving space 276 is defined in a receiving height direction 277.

Preferably, the one retaining element 274, which in particular is arranged closer to the insertion side 248 than the other retaining element 272a, is stepped and preferably formed as in the first exemplary embodiment.

In this exemplary embodiment, the other retaining element 272a is spring-loaded and, in particular, is part of a disk spring 422 shown by way of example in FIG. 10.

In particular, the retaining element 272a is a radially outer portion relative to a spring axis 442 of the disk spring 422 and extends, for example, in the circumferential direction only in regions in which a connection receptacle 262a is arranged.

For example, the stop ring 242a has a corresponding recess 128 in the region of the connection receptacles 262a, through which recess the portion of the disk spring 422 forming the retaining element 272a protrudes and defines the receiving space 276 as the retaining element 272a with the other retaining element 274.

In particular, the portion of the disk spring 422 forming the retaining element 272a protrudes slightly in the direction of the receiving height direction 277 beyond the stop surface 244 of the stop ring 242a in the direction of the other retaining element 274.

Preferably, the portion of the disk spring 422 forming the retaining element 272a has a guide portion 432 arranged at the opening end 342 of the connection receptacle 262a, which guide portion has an inclined guide surface moving away from the other retaining element 274 in the receiving height direction 277, so that the insertion of a connection mating piece 152 is preferably facilitated.

For example, the disk spring 422 also has at least one spring leg 436 in a radially inner portion, which is supported on a stop in the functional part 110a, so that the disk spring 422 is held resiliently in the functional part 110a.

In particular, the disk spring 422, in particular the resiliently held portion forming the retaining element 272a and, for example, the at least one spring leg 436, is configured to compensate for tolerances in the connection mating piece 152.

For example, a spring travel of the disk spring 422, in particular of the portion forming the retaining element 272a and/or of the at least one spring leg 436, is in the range of tenths of a millimeter.

In particular, an advantage of this embodiment is that the resilient mounting of the one retaining element 272a provides tolerance compensation for inaccuracies in the connection mating piece 152 and this is held stably in the connection receptacle 262 even with large tolerances.

Preferably, the functional part 110a and the housing 120 are configured at least partially as explained in conjunction with the first exemplary embodiment, and therefore reference is made in full to the preceding explanations with regard to advantageous features of them, in particular with regard to advantageous forms of the other retaining element 274, which in particular is stepped, and/or the plurality of connection receptacles 262I, 262II, 262III and their corresponding connection mating pieces 152I, 152II, 152III, and/or the receiving space 276, which in particular comprises a plurality of receiving partial spaces 332, 334, 336 with respective pairs of contact surfaces, wherein in particular at least one portion of the portion of the disk spring 422 forming the resiliently mounted retaining element 272a in each case forms a contact surface of the pair of contact surfaces, and/or with regard to free spaces 392 between the connection receptacles 262 and/or with regard to an engagement body 232 and/or with regard to a functional component 212 of the functional part 110 and/or with regard to the housing 120, 120′, 120″, 120′″ and its housing opening 126, wherein advantageously the functional part 110a can be fastened to a housing opening 126 in housing walls 124′, 124″, 124′″ with different thicknesses.

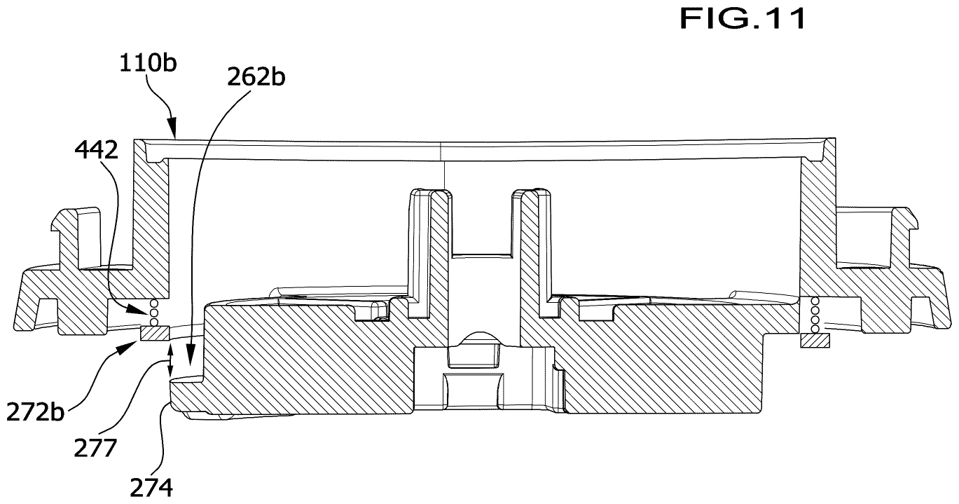

In a further exemplary embodiment of a functional part 110b, which is shown by way of example in FIG. 11, a retaining element, for example a retaining element 272b, is resiliently mounted on a spring 442, for example a spiral spring, with a large spring travel, so that the movable mounting of the retaining element 272b relative to the other retaining element 274 makes it possible to adapt a receiving height in a receiving height direction 277 of the connection receptacle 262 for different thicknesses of the connection mating piece 152 to be received.

In particular, the spring 442 resiliently and movably supporting the retaining element 272b has a large spring travel for this purpose, which is greater than 1 mm, for example, in order to compensate for sufficiently different thicknesses of the connection mating piece 152 to be received.

In particular, the resiliently mounted retaining element 272b is held movably and in a resiliently mounted manner in the receiving height direction 277.

In some variants, the other retaining element 274 is stepped, such as in one of the exemplary embodiments explained above, to allow for even greater variability in the possible thicknesses of connection mating pieces 152 to be received.

In other favorable variants of the exemplary embodiment, the other retaining element 274 has a substantially flat contact surface, so that a structurally simple solution is provided.

Preferably, the functional part 110b and the housing 120 with the housing opening 126 are configured as in one of the exemplary embodiments explained above, and therefore reference is made in full to the above explanations with regard to advantageous configurations, in particular to the explanations with regard to the connection receptacles 262, for example the plurality of connection receptacles 262I, 262II, 262III, and the connection mating pieces 152 received by them, in particular the connection pieces 152I, 152II, 152III, and/or with regard to free spaces 392 between the connection receptacles 262 and/or with regard to an engagement body 232 and/or a functional component 212 of the functional part 110b and/or with regard to advantageous embodiments of the housing 120 with, for example, a housing part 122 and the housing opening 126, into which the connection mating pieces 152 project.

### LIST OF REFERENCE NUMERALS (WITHOUT A CORRESPONDING LETTER CHARACTERIZING THE EXEMPLARY EMBODIMENT)

110 functional part
120 housing
122 housing part
124 housing wall
126 housing opening
132 outer side
134 inner side
136 outer surface
138 inner surface
142 opening edge
146 opening axis
152 connection mating piece
162 outer ring region
164 inner region
212 functional component
214 fluid passage
218 fastening element
232 engagement body
234 connection axis
236 engaging side
238 cylindrical outer side
242 stop ring
244 stop surface
248 insertion side
252 axial end
262 connection receptacle
272 retaining element
274 retaining element
276 receptacle space
277 receiving height direction
278 longitudinal direction of extent
282 retaining portion
284 contact surface
312 step portion
314 step portion
316 step portion
322 contact surface
324 contact surface
326 contact surface
332 receiving partial space
334 receiving partial space
336 receiving partial space
342 opening end
344 receiving opening
346 rear end
348 terminating stop
352 step
354 step
362 end stop
364 end stop
366 end stop
372 detent member
374 detent member
376 detent member
382 guide surface
384 guide surface
386 guide surface
388 open longitudinal side
392 free space
396 closing direction of rotation
422 disc spring
424 spring axis
428 recess
432 guide portion
436 spring leg
442 spring

What is claimed:

1. A functional part, the functional part comprises at least one connection receptacle, wherein the at least one connection receptacle is configured to receive a connection mating piece of another part in order to securely and releasably connect the functional part to the other part, wherein the at least one connection receptacle is configured to receive connection mating pieces of different sizes.

2. The functional part in accordance with claim 1, wherein the at least one connection receptacle is configured to receive a connection mating piece of another part in the form of a bayonet closure.

3. The functional part in accordance with claim 1, wherein the at least one connection receptacle has a receiving space which comprises a plurality of receiving partial spaces and the plurality of receiving partial spaces have different receiving heights.

4. The functional part in accordance with claim 1, wherein the at least one connection receptacle comprises at least one retaining element, wherein at least one of the following:
at least two retaining elements are spaced apart from one another in a receptacle height direction;
in the at least one connection receptacle a receiving space is formed at least partially between at least two retaining elements;
in the at least one connection receptacle the at least one retaining element forms at least one contact surface.

5. The functional part in accordance with claim 1, wherein at least one retaining element of the at least one connection receptacle comprises a plurality of step portions, wherein the plurality of step portions are arranged offset relative to one another in a receiving height direction.

6. The functional part in accordance with claim 1, wherein at least one retaining element of the at least one connection receptacle has a contact surface which is flat at least in the receiving space along its at least approximately entire longitudinal extent.

7. The functional part in accordance with claim 1, wherein the at least one connection receptacle comprises at least one end stop and the at least one end stop is arranged with respect to an insertion direction for the connection mating piece at at least one of a rear end of at least one receiving partial space of the at least one connection receptacle and/or a rear end of at least one contact surface of the at least one connection receptacle.

8. The functional part in accordance with claim 1, wherein the at least one connection receptacle comprises at least one end stop and the at least one end stop is formed by a step between two adjacent step portions.

9. The functional part in accordance with claim 1, wherein the at least one connection receptacle comprises at least one detent member, wherein the at least one detent member is arranged with respect to the insertion direction for the connection mating piece at at least one of a front end of at least one receiving partial space of the at least one connection receptacle and/or a front end of at least one contact surface of the at least one connection receptacle.

10. The functional part in accordance with claim 1, wherein the at least one connection receptacle comprises at least one guide surface wherein the at least one guide surface extends in an insertion direction for the connection mating piece and runs at an angle to a receiving height direction and the at least one guide surface is arranged with respect to the insertion direction for the connection mating piece in front of at least one of at least one receiving partial space of the at least one connection receptacle and/or at least one contact surface of the at least one connection receptacle.

11. The functional part in accordance with claim 1, wherein the at least one connection receptacle comprises at least one guide surface wherein the at least one guide surface at least on of transitions at least partially into at least one detent member and/or is formed at least partially from at least one detent member.

12. The functional part in accordance with claim 1, wherein at least two retaining elements of the at least one connection receptacle are arranged rigidly relative to one another.

13. The functional part in accordance with claim 1, wherein at least one retaining element of the at least one connection receptacle is force-loaded.

14. The functional part in accordance with claim 1, wherein an application of force to at least one force-loaded retaining element of the at least one connection receptacle is configured for tolerance compensation.

15. The functional part in accordance with claim 1, wherein an application of force to at least one force-loaded retaining element of the at least one connection receptacle is configured to compensate for the height of the receiving space for receiving connection mating pieces of different sizes.

16. The functional part in accordance with claim 1, wherein at least one retaining element of the at least one connection receptacle is arranged on an engagement body, the engagement body being configured to engage in an opening of the other part in the one connection state.

17. The functional part in accordance with claim 1, wherein at least one retaining element of the at least one connection receptacle is formed by a stop element for the other part.

18. The functional part in accordance with claim 1, wherein a plurality of connection receptacles are arranged in a ring region around a connection axis.

19. The functional part in accordance with claim 1, wherein the functional part is a fluid-guiding part.

20. A functional system with at least one functional part in accordance with claim 1 and another part for forming a connection.

21. The functional system in accordance with claim 20, wherein the other part for forming a connection to the functional part is a housing part of a housing of the functional system.

22. The functional system in accordance with claim 20, wherein the other part has an opening wherein the one connection mating piece or a plurality of connection mating pieces protrude from an opening edge of the opening into the opening.

23. The functional system in accordance with claim 21, wherein the housing is a battery housing.
